(19) United States
(12) Patent Application Publication
(10) Pub. No.: US 2005/0060236 A1
(43) Pub. Date: Mar. 17, 2005

(54) System and method for managing and insuring personal inventory

(75) Inventor: Bernard A. Iulo, Poughkeepsie, NY (US)

Correspondence Address: Philmore H. Colburn II;Cantor Colburn LLP, 55 Griffin Road South, Bloomfield, CT, 06002, US

(73) Assignee: International Business Machines Corporation, Armonk, NY (US)

(21) Appl. No.: 10/653,873

(22) Filed: Sep. 3, 2003

(51) Int. Cl. G06F 17/60

(52) U.S. Cl. 705/26

(57) ABSTRACT

A method for providing and updating a personal inventory of personal belongings during an on-line transaction, comprising: providing a storage medium wherein the personal inventory of an individual or individual's property is stored, said storage medium being at a location remote to the location of the individual's property such that in the event of a loss of the property, the personal inventory is accessible to provide comprehensive information related to the property; and providing a link to a server system having or being linked to the storage medium during the conclusion of the online transaction wherein the option of storing information related to an on-line purchase at the storage medium is provided.

### TECHNICAL FIELD

The invention relates to a system and methodology for managing and ensuring that a personal inventory is available in the event of loss or damage to items in the inventory.

### BACKGROUND

Maintaining a personal inventory is very important when a tragedy such as a fire, flood, storm etc. wipes out all or part of a home. In addition, if a personal tragedy such as a death or incapacitating illness strikes an individual or the individual is no longer able to care for themselves, the personal inventory may be a very valuable tool for settling the affairs or managing the estate of affected person. Keeping product specifications and warranty information is also very important should there be a need for product service or support or as discussed above the product information may be required in the event of a loss when making an insurance claim.

In recent years more and more consumers are buying items on the Internet or other networking systems. An individual may desire to include some of these items in a personal inventory for latter use in the event of personal tragedy such as a fire, wherein the information is useful for insurance claims or replacement costs or even just finding an equivalent item. The Internet and/or other networking systems allows a vast number of devices such as but not limited to computers, personal data assistants (PDAs), cell phones, kiosks or other electronic devices to access multiple computer networks each being interconnected through communication links wherein information is exchanged through the Internet (e.g., telephone, DSL, cable, wireless etc.). Accordingly, the Internet and/or other networking systems are conducive to conducting electronic commerce.

Servers provide a means wherein a business can advertise and sell products over a network or the Internet. The products, if purchased, are shipped via mail or other courier. In order to facilitate the transaction the server will typically include an electronic version of a catalog that lists the items that are available. A potential purchaser, may browse through the catalog using a browser and select various items that are to be purchased.

When the user has selected the items to be purchased, the server, or computer system or server computer system then prompts the user for information to complete the ordering of the items. This purchaser-specific order information may include the purchaser's name, the purchaser's credit card number or other form of payment and a shipping address for the order. The server computer system then typically confirms the order by sending a confirming Web page to the client computer system and schedules shipment of the items.

The selection of the various items from the electronic catalogs is generally based on the “shopping cart” model. When the purchaser selects an item from the electronic catalog, the server computer system metaphorically adds that item to a shopping cart. When the purchaser is done selecting items, then all the items in the shopping cart are “checked out” (i.e., ordered) when the purchaser provides billing and shipment information. In some models, when a purchaser selects any one item, then that item is “checked out” by automatically prompting the user for the billing and shipment information.

However, there still remains a need for compiling a personal inventory of purchased items, which is very important when a tragedy such as a fire wipes out all or part of a home. Keeping product specifications and warranty information is also very important should there be a need for product service or support or as discussed above the product information may be required in the event of a loss when making an insurance claim. Accordingly, it is desirable to include information about products purchased via on-line transactions as well as in store transactions.

Moreover, a typical online purchase is usually confirmed with an e-mail reply, which requires the consumer to print it out for a permanent copy. This procedure creates yet another document which the consumer may want to include in a personal inventory.

### SUMMARY OF THE INVENTION

Exemplary embodiments disclosed herein describe a method and system for providing a personal inventory of items which allows the owner of these items to replace them in the event of a loss of the original item.

An exemplary embodiment of the present invention is a comprehensive system that will build and maintain the personal inventory for household into a personal database. Additions and updates to the databases can be made in a variety of ways. The provider of this database for purposes of explanation is an electronic vital records warehousing (hereinafter, EVRW) company. Consumers will open accounts with these providers to keep their records in a secure environment and in a manner that is accessible by the consumer. Once their account is established the consumer can begin their personal inventory using an assigned (EVRW) identification and password.

A method for providing and updating a personal inventory of personal belongings during an on-line retail transaction is also provided. The method comprises: providing a storage medium wherein the personal inventory of the indivdual or individuals property is stored, the storage medium being at location remote to the location of the individuals property such that in the event of a loss of the property, the personal inventory is accessible to provide comprehensive information related to the property; and providing a link to a server system having or being linked to the storage medium during the conclusion of the online retail transaction wherein the option of storing information related to the online retail transaction is provided.

A method for providing and maintaining a personal inventory of personal belongings is provided. The method comprises: providing a storage medium wherein the personal inventory of the individual or individuals property is stored, said storage medium being at location remote to the location of the individuals property such that in the event of a loss of the property, the personal inventory is accessible to provide comprehensive information related to the property; and updating the information contained in the personal inventory by accessing the storage medium via a computer system network communications link of a non-online retail transaction wherein data in computer readable format is submitted to a server system in communication with the storage medium.

Also provided is medium encoded with a machine-readable computer program code for providing and updating a personal inventory of personal belongings, the medium including instructions for implementing the method comprising: providing a remote storage medium wherein the personal inventory of an indivdual or individuals property is stored, the storage medium being locatable on a server system remote to the location of the individuals property such that in the event of a loss of the property, the personal inventory is accessible to provide comprehensive information related to the property; and providing a link to said server system having or being linked to said storage medium wherein the link is either provided at the conclusion of the online transaction wherein the option of storing information related to an on-line retail purchase is provided or via an Internet and/or other networking systems communications link in non-online retail purchase transaction wherein data in computer readable format is submitted to said server system in communication with the storage medium.

These and other embodiments are described in the following detailed description, which refer to the drawings.

### DESCRIPTION OF THE DRAWINGS

FIG. 1 is a schematic illustration of linking a consumer's on-line transaction to a remote database in accordance with an exemplary embodiment of the present invention;

FIG. 2 is a block diagram of a portion of a control algorithm for use in accordance with an exemplary embodiment of the present invention;

FIG. 3 is an illustration of icons or interfaces presented to a consumer during an on-line purchase from an on-line retailer, which is employing an exemplary embodiment of the present invention; and

FIG. 4 is a block diagram of a portion of a control algorithm for use in accordance with an alternative exemplary embodiment of the present invention.

### DETAILED DESCRIPTION OF EXEMPLARY EMBODIMENTS

Referring now to the Figures and in accordance with an exemplary embodiment of the present invention, a method for compiling a personal inventory, which is readily accessible and stored at a location remote to the individual's home or actual location of the property is provided.

As more and more individuals are making more purchases online via computer networks and related systems, as opposed to going to a traditional store, an excellent source for this type of vital records is available at the time of purchase. An exemplary embodiment of this invention will connect all of this technology together to form a product and service that can be offered by either shopping sites on the Internet and/or other networking systems, or an electronic vital records warehousing company or by a variety of insurance providers or even by an independent entrepreneur.

Many consumer products also come with service contracts or may be separately insured. An exemplary embodiment of this invention will also factor in both of these items. For service contracts, the specific terms and conditions for each product's service contract will be stored electronically with the personal inventory. This provides the consumer with instant access to this information should a problem occur. An exemplary embodiment of this invention also allows for products, for example a piece of jewelry purchased to be separately insured with the product invoice, description and insurance policy all being kept together online at the EVRW company.

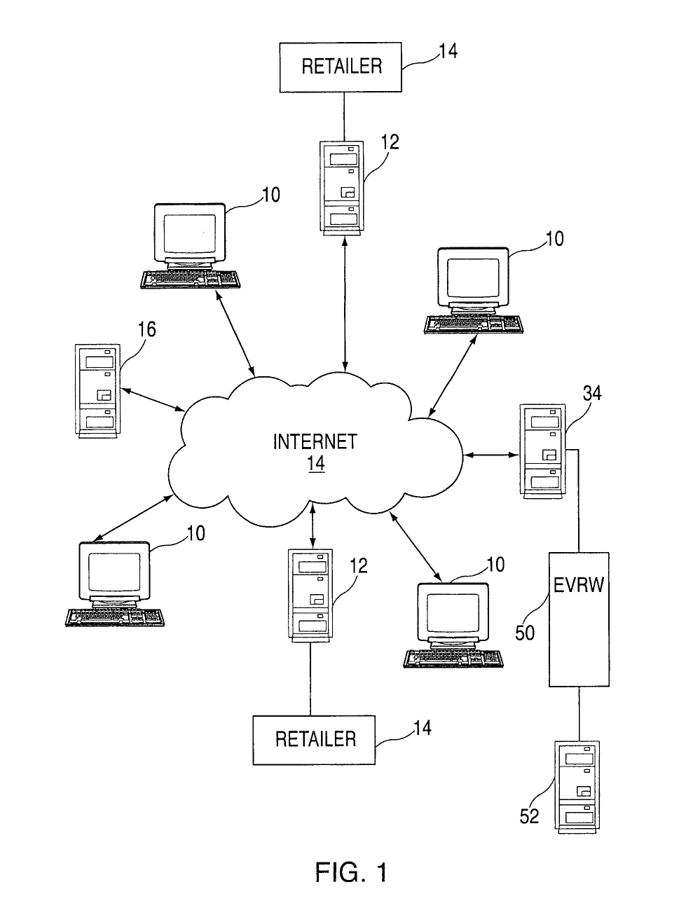

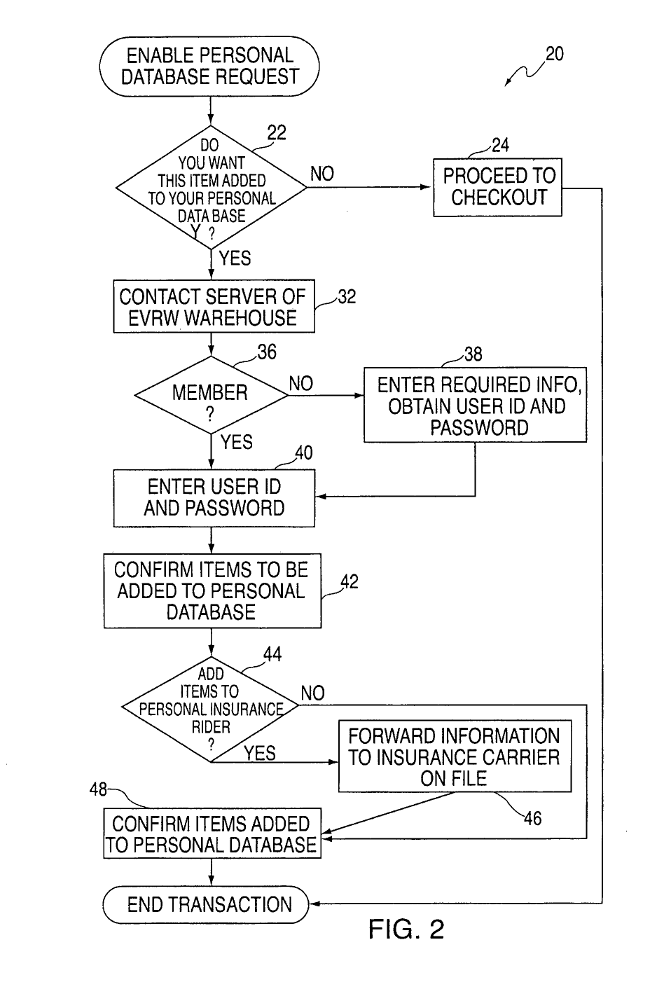

Referring now to FIGS. 1 and 2, and in accordance with an exemplary embodiment, a schematic illustration of a method for building and maintaining a personal inventory for an individual or a household into a personal database during an on-line transaction is provided. With the advent or acceptance of the Internet and other equivalent networking systems as a means for conducting retail transactions, as well as other transactions an individual is capable of purchasing and receiving a retail item without every leaving the comforts of their home.

An individual through the use of a computer or equivalent network access apparatus or system 10 is able to conduct transactions online by accessing servers or other networking apparatus 12 through the Internet or network 14 in accordance with known technologies. For example, computer or computer system 10 comprises a motherboard, a CPU, memory (e.g., random access memory (RAM), dynamic ram (DRAM), static RAM (SRAM), synchronous DRAM (SDRAM), flash RAM, read-only memory (ROM), programmable ROM (PROM), erasable PROM (EPROM), and electrically erasable PROM (EEPROM)), and other optional special purpose logic devices (e.g., application specific integrated circuits (ASICs)) or configurable logic devices (e.g., generic array of logic (GAL) or reprogrammable field programmable gate array (FPGA)). The computer also comprises a plurality of input devices (e.g., a keyboard and a mouse) and a display card for controlling a monitor. In addition, the computer system further includes a floppy disk drive or other removable media devices (e.g., a compact disc, a tape, and a removable magneto-optical media); and a hard disk, or other fixed, high density media drives, connected using an appropriate device bus (e.g., a small computer system interface (SCSI) bus, an enhanced integrated device electronics (IDE) bus, or an ultra direct memory access (DMA) bus). Also connected to the same device bus or another device bus, the computer may additionally include a compact disc reader, a compact disc reader/writer unit. In addition, a printer can be coupled to an output port of the computer to print any data stored and/or generated by the computer. Any combination of the aforementioned components, as well as equivalents thereof, allow an individual to conduct on-line business via access to the Internet or network.

In addition, and in accordance with known technologies, servers and computer systems 12 each comprise motherboards, CPUs, memory, logic devices and a plurality of input/output devices and other devices for communicating with other servers and data storage systems in order to complete on-line transactions as well as provide information. Servers 12 are also configured to communicate with an on-line retailer 14, which is coupled to server 12. Thus, many individuals through multiple computer systems 10 are able to access network 14 from one or more geographical locations, to initiate exemplary embodiments of the present invention. It is understood that network 14 may be any type of known network including, but not limited to the following or combinations thereof, a wide area network (WAN), a local area network (LAN), a global network (e.g., Internet), a virtual private network (VPN) and an intranet. The network may be implemented using a wireless data transfer or any kind of physical network known in the art.

In accordance with an exemplary embodiment, an individual is able to build and maintain a personal inventory for an individual or a household by accessing a personal database during an on-line transaction. This is accomplished by accessing a server 16 of an electronic vital records warehousing (EVRW) company during an on-line transaction. More particularly, the personal database is accessed/updated or built during the completion of the on-line transaction.

As is known in the related arts various means have been employed to help streamline and facilitate the on-line transaction as well as build up a unique customer profile. For example, the “shopping cart method” or the “one click method” disclosed in U.S. Pat. No. 5,960,411 are but a few examples of such a method for completing the on-line transaction.

In accordance with an exemplary embodiment involving an on-line transaction, a method for providing the consumer with an opportunity to add their on-line purchase to their personal database is provided. An interface will be provided by an electronic vital records warehousing (EVRW) company or entity so that when a consumer is completing their purchase and at the check out phase of the on-line transaction they can be prompted if they would like to update their personal inventory with this purchase.

At the conclusion of an “on-line” purchase, the consumer will, in accordance with an exemplary embodiment of the present invention, be prompted by a control algorithm 20, which is enabled to execute a series of instructions once the consumer has reached a point in the on-line transaction wherein the “shopping cart”, “one click” or equivalent technology has been employed. Algorithm 20 in one embodiment will comprise a portion of the software or algorithms employed on the retail servers to conduct the “shopping cart” or “one-click” transactions. Alternatively, algorithm 20 will be enabled when the on-line purchase has been completed. In yet another alternative, algorithm 20 is a separate program activated by a separate icon which can be located in the same location as the icon which enables the “shopping cart” or “one click” transaction technology or alternatively algorithm 20 is located on a server of the EVRW. Algorithm 20 is provided as an example of a portion of a control system for implementing exemplary embodiments of the present invention and is not intended to limit the present invention to the same. For example, additional steps may be included or steps may be removed and/or the ordering of the steps may be different.

Currently many Internet shopping web sites use a shopping cart and a gift box as a link or interface to a program which provides the desired output. The shopping cart is used to add items to the list of items being purchased. The gift box is used to signify either gift wrapping or gift registration. In each of the previous examples the icon provides the user with a quick link for enabling the desired function or a program. In accordance with an exemplary embodiment of the present invention there are potentially at least two new symbols which may be used to identify with or provide immediate access to an EVRW company. The first is in the form of a list with a checkmark which is used to invoke the present invention. The customer using the symbol tells the shopping system that this item is to be added to their personal inventory and also that the invention is installed and running on the system of the on-line retailer. The shopping network will then provide the invoice warranty information and product description over the interface to the EVRW company. The EVRW company will then add these items to the personal database corresponding to the consumer.

The second symbol will be of a security/insurance image which is to be used if the customer wants to obtain additional insurance protection. The shopping network can either handle that transaction on their own or pass the indicator back to the EVRW company. If passed back to the EVRW company, the program will provide interface from which insurance companies/programs can be used to handle the transaction. If the customer already has an existing policy the program can query the insurance company using an interface to determine if an insurance rider is required in order to insure the new item.

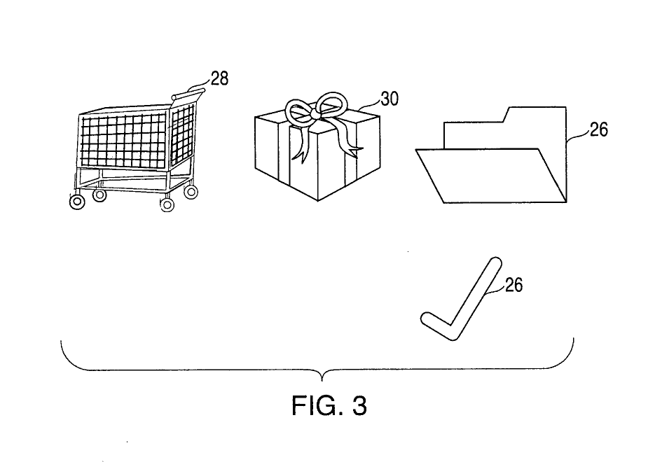

For example, and referring to now FIG. 3, a file folder or checkmark 26 can be displaced along side a shopping cart icon 28 and a gift box icon 30. Of course, any other type of icon may be used to enable algorithm 20, such as a security/insurance image to invoke access to either the EVRW company or an insurance company or both.

Referring back now to FIG. 2, and upon enablement of control algorithm 20, which is enabled by one of the aforementioned symbols or steps during an on-line transaction, a first step or decision node 22 will provide a prompt asking the consumer whether they would like to include or add this item to their personal database of an electronic vital records warehousing (EVRW) company or entity. An example of such a prompt may include the following question: “Do you want this item added to your personal database?” or equivalents thereof. If the answer or input from the consumer is no, a step 24 will instruct the algorithm to end, and the on-line transaction will be completed.

If on the other hand the answer is yes, a step 32 will instruct a server (e.g., web server) 34 (FIG. 1) of an electronic vital records warehousing (EVRW) company or entity to be accessed via communication means currently employed using the Internet or network as a communications medium. For example, a list of (EVRW) providers will be shown and the consumer will be asked to select the provider. Alternatively, server 34 may be a portion of, or a secondary server associated with an on-line retailer. Once the server of the electronic vital records warehousing (EVRW) company or entity is accessed a step or decision node 36 will ask the consumer if they already have an electronic vital records account or are a member of the (EVRW) company. If the answer is no a step 38 will run an algorithm or routine wherein a series of questions are asked and the consumer will have an account set up with a user name and password which can be used in future transactions. The user name and password can then be used when additional information is being added to the electronic records database.

On the other hand if the answer is yes, a step 40 will ask the consumer to enter their user id and password thereby allowing access to their personal account. Once the user id and password has been entered, a step 42 will confirm the items being purchased are being added to the personal database corresponding to the user id and password. Once the purchased items are added to the personal database, a step or decision node 44 will ask the consumer if they would like to add the items to their personal insurance. For example, if the consumer has just bought some expensive jewelry, which they would like to add to their insurance (e.g., a home owner's insurance policy) the information corresponding to the purchase (e.g., purchase price, specifications, serial numbers etc.) can be immediately sent to the insurance carrier via communication means currently employed using the Internet or equivalent networking systems as a communications medium. This process or portion of the algorithm is performed at step 46 in response to an affirmative response to the question posed at decision node 44. The consumer will then be billed by his or her insurance carrier. In an exemplary embodiment, the insurance carrier and the EVRW company are one in the same. Of course, they can be separate entities.

Once the insurance information has been submitted or if the consumer indicates that they are not interested in including this item in their insurance policy a step 48 will confirm that the newly purchased items have been added to their personal database. As an alternative, algorithm 20 is configured to not have the steps related to the option of including the recently purchased items to an insurance company.

Upon completion of the transaction, a personal database is stored in a EVRW depository 50, which will comprise electronic means for receiving and storing the information corresponding to the items stored in the EVRW depository. An example of the electronic means is for example, the components discussed above with regard to the computers and servers. A user may be coupled to the EVRW through multiple networks (e.g., intranet and Internet) so that not all users are coupled to the EVRW through the same network. In addition, users may be connected to the network in a wireless fashion.

The depository or storage device 50 may be implemented using a variety of devices for storing electronic information. It is understood that the storage device or depository 50 may be implemented using memory contained in server 34 or it may be a separate physical device. The storage device is logically addressable as a data source across a distributed environment that includes network 10. The actual physical data of server 34 may be located in a variety of geographic locations depending on application and access requirements. The functions of server 34 may be implemented using one or more servers operating in response to a computer program stored in a storage medium accessible by the server. The server may also operate as a network server (e.g., a web server) to communicate with the computer systems 10. In an exemplary embodiment, server 34 will handle the sending and receiving information to and from the computer systems 10.

In addition, and as an alternative a backup server 52 is in communication with depository 50 in order to provide an alternative source of information in the event depository 50 becomes inoperative or unreachable. Once the specific EVRW used by the consumer is selected the online shopping business will then directly send them the following information, which includes but is not limited to: invoice; product descriptions and specifications; maintenance manuals; and service plan information.

For service contracts or warranties, extended warranties etc., which are purchased during the on-line transaction or are included in the purchase price, the specific terms and conditions for each product's service contract will be stored electronically with the personal inventory. This provides the consumer with instant access to this information should a problem occur with the product or there is a complete loss due to a personal tragedy.

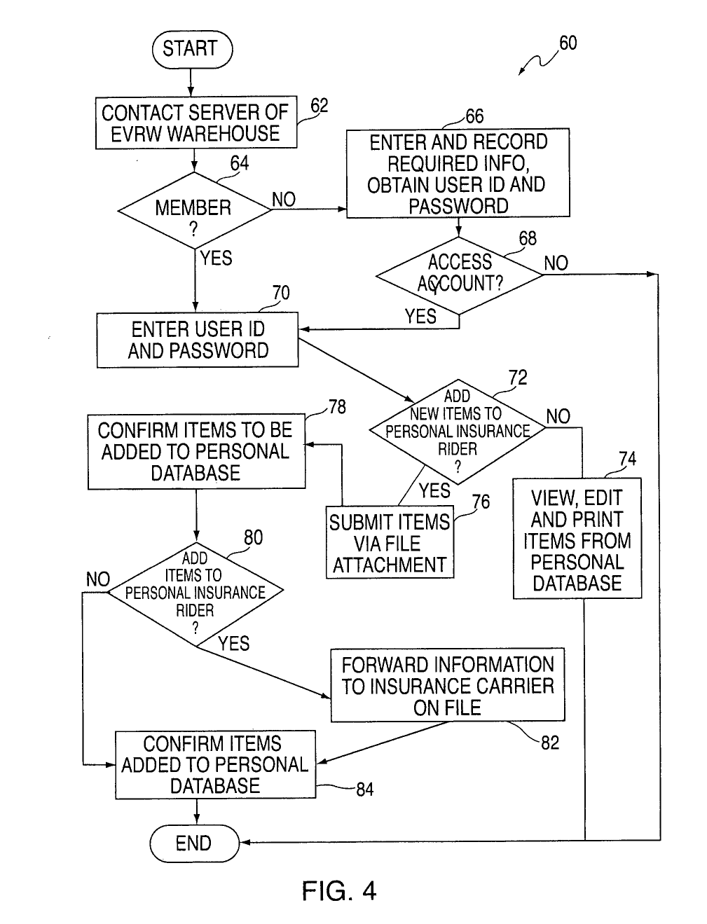

Referring now to FIG. 4, an alternative embodiment is illustrated. In this embodiment, the personal inventory is created of items already in possession of an individual. Here, information related to the items being added is recorded or created via a device or devices (camera (video, digital, etc.) scanner, facsimile machine, etc.) and related software capable of creating a digital or electronic document representative of the personal item. Then the electronic document containing the information is sent to the (EVRW) company or entity via communication means currently employed using the Internet, network or other networking system as a communications medium.

Video cameras, digital cameras, fax machines and scanners and related software applications are readily available to provide digital information in a variety of manners wherein an individual can compile relevant information about personal items. Therefore, there is a vast amount of accessible technology available to provide a personal inventory in a very comprehensive manner.

For example, after a purchase is completed by a customer at a retail store they can take their invoice and product home. Using a fax machine, scanner, digital camera or other equivalent item, the customer can download a copy of the invoice onto their personal computer. In addition, user manuals and a digital picture of the product can also be stored onto their personal computer. Once the consumer is ready to load their personal information into their account at the EVRW warehouse, the consumer accesses the Internet, network or other networking system in accordance with known technologies and the consumer will logon to the web site for the EVRW warehouse of their choosing.

An individual may want to add legal or other documents to their personal database, the documents may include but are not limited to the following: wills, trusts, life insurance policies, deeds, stock certificates, bonds, tax returns, financial information, etc. wherein it would be desirable to have a copy of such information in the event a personal tragedy such as a fire or theft causes these documents to become destroyed or unavailable. In addition, if a personal tragedy such as a death or incapacitating illness strikes an individual or the individual is no longer able to care for themselves, the personal inventory may be a very valuable tool for settling the affairs or managing the estate of affected person.

FIG. 4, illustrates portions of a control algorithm 60, which is enabled when a user accesses an EVRW warehouse from an Internet or network connection, algorithm 60 illustrates some of the steps for creating, accessing and/or modifying the contents of a personal database in accordance with an exemplary embodiment of the present invention.

Upon enablement of control algorithm 60, which is enabled by one of the aforementioned symbols or steps, a step 62 will instruct a server 34 (FIG. 1) of an electronic vital records warehousing (EVRW) company or entity to be accessed via communication means currently employed using the Internet, network or other networking system as a communications medium. Once the server of the electronic vital records warehousing (EVRW) company or entity is accessed a step or decision node 64 will ask the consumer if they already have an electronic vital records account or are a member of the (EVRW) company. If the answer is no, a step 66 will run a algorithm or routine wherein a series of questions are asked and upon completion of the required responses the consumer will have an account set up with a user name and password which can be used in future transactions wherein additional information is added to the electronic records database.

Once the necessary information has been entered, a step or decision node 68 will inquire whether the individual wants to access their new account. If yes, the individual will enter their user id and password thereby allowing access to their personal account. If no, the program will end and the individual is logged out.

On the other hand if the answer is yes to either node 64 or 68, a step 70 will ask the individual to enter their user id and password thereby allowing access to their personal account. Once the user id and password has been entered a decision node or step 72 will ask the account holder if they want to add new items or information to their personal database.

If the answer to the question posed by decision node 72 is no, a step 74 will then ask the user if they would like to view, edit or print information from their personal database, wherein the user may view or modify their personal account information.

If on the other hand the answer is yes, a step 76 will prompt the user to attach the new information via a file attachment, which in accordance with an exemplary embodiment may be any digital file format or electronic medium (e.g., *.tif, *.jpeg, *.pdf, etc. and equivalents thereof) capable of transferring an accurate representation of the required information via an Internet or network connection to the server of the EVRW company. A step 78 will then confirm the items being added to the personal database of the account holder. Thus, the vital information is now stored in an electric storage medium at a location remote to the actual location of the related property.

Once the items are added to the personal database, a step or decision node 80 will ask the consumer if they would like to add the items to their personal insurance. For example, if the consumer has just bought some expensive jewelry, which they would like to add to their insurance (e.g., a home owner's insurance policy) the information corresponding to the purchase (e.g., purchase price, specifications, serial numbers etc.) can be immediately sent to the insurance carrier via communication means currently employed using the Internet as a communications medium. This process or portion of the algorithm is performed at step 82 in response to an affirmative response to the question posed at decision node 80. The consumer will then be billed by his or her insurance carrier. In an exemplary embodiment, the insurance carrier and the EVRW company are one in the same. Of course, it is contemplated that the insurance carrier and the EVRW can be separate entities.

Once the insurance information has been submitted or if the consumer indicates that they are not interested in including these items in their insurance policies a step 84 will confirm the items have been added to the personal database. Since this portion of the EVRW company is being accessed in relation to a non-online retail transaction, the consumer supplies the EVRW company with the attached electronic copy of the invoice wherein information corresponding to the manufacturer's name and product model can be searched for a match. If found, the EVRW will build a link for this information which will be provided to the user for storage in their personal database, such information may include but is not limited to the following: invoice; product descriptions and specifications; maintenance manuals; and service plan information. In the case of a used item being stored to the database wherein the original sales receipt is not available this information is particularly useful in ascertaining a valve of the item wherein replacement costs and description thereof can be calculated. As an alternative to lifting the information directly from the scanned in invoice, the user may manually enter the required information (e.g., manufacturer's name, serial number and product model) in order to provide a link to additional information which will be provided to the user for storage in their personal database. For example, supplying the make, model and serial number of a television set may allow the program to locate an Internet link wherein product specifications of the item are available for storage into the personal database. This information is very helpful in assessing a replacement cost of the item in the event of a loss.

As an alternative, algorithm 60 is configured to not have the steps related to insurance of the item recently added to the personal database.

Upon completion of the transaction, a personal database is stored in a EVRW depository 50 (FIG. 1), which will comprise electronic means for receiving and storing the information corresponding to the individual's personal items. An example of the electronic means is, for example, the components discussed above with regard to the computers and servers.

By compiling, accessing and modifying a personal database at an EVRW warehousing company the owner of the contents in the database is able to have an efficient means for organizing personal inventory and vital records about purchases. Through the usage of web accessibility to product manufactures as well as insurance companies the information is easily compiled and/or updated. Moreover, easy access to service and warranty information is provided. Therefore, an individual does not have to worry about where their refrigerator warranty or owner's manual is several months or even years after the initial purchase.

In addition, and if the owner of the personal database experiences a personal tragedy wherein all or some of the items in the database are lost, the corresponding files can be sent to the insurance carrier for ease of replacement or reimbursement.

Software for implementing the various exemplary embodiments of the present invention may include, but is not limited to, device drivers, operating systems and user applications, such as development tools. Computer readable media for implementing the various exemplary embodiments of the present invention may include, a computer program product of an exemplary embodiment for performing all or a portion (if processing is distributed) of the processing performed in implementing the various exemplary embodiments. The computer code devices for exemplary embodiments of the present invention can be any interpreted or executable code mechanism, including but not limited to scripts, interpreters, dynamic link libraries, Java classes, and complete executable programs, wherein portions of the processing may be distributed for better performance, reliability, and/or cost.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It should also be noted that the terms “first”, “second”, and “third” and the like may be used herein to modify elements performing similar and/or analogous functions. These modifiers do not imply a spatial, sequential, or hierarchical order to the modified elements unless specifically stated.

1. A method for providing and updating a personal inventory of personal belongings during an on-line transaction, comprising:
providing access to a storage medium wherein the personal inventory of an individual or individual's property can be stored, said storage medium being at a location remote to the location of the individual's property such that in the event of a loss of the property, the personal inventory is accessible to provide comprehensive information related to the property; and
providing access to a link of a server system having or being linked to said storage medium during the conclusion of the online transaction wherein the option of storing information related to the on-line purchase at the storage medium is provided, said link to said storage medium connecting to a network wherein requests for accessing said storage medium are facilitated and access to said storage medium is offered through said link.

2. The method as in claim 1, wherein said link is presented to a consumer immediately after the completion of said on-line purchase.

3. The method as in claim 1, wherein said link is presented to a consumer in the form of an icon.

4. The method as in claim 1, wherein said link is an algorithm which executes the following commands to place information related to the on-line purchase into the storage medium:
inquiring whether the consumer has a user id and password allowing the consumer to access an account related to said storage medium;
obtaining information, if necessary, to open a new account related to said storage medium;
providing access to an individual account of said storage medium wherein information related to said on-line purchase is stored into a database corresponding to said individual account;
providing the option of forwarding information related to said on-line purchase to a server system of an insurance company; and
updating the information contained in the personal inventory by accessing said storage medium via a network communications link wherein data related to the on-line purchase in computer readable format is submitted to a server system in communication with said storage medium.

5. The method as in claim 4, wherein said algorithm is enabled through the use of an icon presented to the consumer at the conclusion of an on-line transaction.

6. The method as in claim 5, wherein the data related to the on-line purchase is obtained from a retail server system via said algorithm.

7. The method as in claim 6, wherein the data includes sales data generated by said retail server system at the conclusion of the transaction.

8. The method as in claim 7, wherein the data includes one or more of the following: invoice information, product specifications, warranty information, operation manuals, manufacturer and product serial number.

9. The method as in claim 4, wherein a first entity provides and maintains said storage medium and a second entity provides and maintains said server system of said insurance company.

10. The method as in claim 9, wherein said first entity and said second entity are one and the same.

11. A method for providing and maintaining a personal inventory of personal belongings, comprising:
providing access to a storage medium wherein the personal inventory of an individual or individual's property is stored, said storage medium being at a location remote to the location of the individual's property such that in the event of a loss of the property, the personal inventory is accessible to provide comprehensive information related to the property; and
updating the information contained in the personal inventory by accessing said storage medium via a network communications link in a non-online retail transaction wherein data in computer readable format is submitted to a server system in communication with said storage medium.

12. The method for providing and maintaining a personal inventory as in claim 11, further comprising an algorithm that executes the following commands or steps:
inquiring whether the consumer has a user id and password allowing access to an account related to said storage medium;
obtaining information, if necessary, to open a new account related to said storage medium;
providing access to an individual account wherein the data is related to personal property of the consumer and is stored into a database corresponding to an account related to said storage medium;
providing the option of forwarding data to a server system of an insurance company; and
accessing other servers in an effort to obtain additional information corresponding to the information being provided to update the information contained in the personal inventory.

13. The method as in claim 12, wherein the data includes any one of the following: invoice information, product specifications, warranty information, operation manuals, manufacturer and product serial number.

14. The method as in claim 13, wherein a first entity provides and maintains said storage medium and a second entity provides and maintains said server system of said insurance company.

15. The method as in claim 14, wherein said first entity and said second entity are one and the same.

16. A medium encoded with a machine-readable computer program code for providing and updating a personal inventory of personal belongings, said medium including instructions for implementing the method comprising:
providing access to a remote storage medium wherein the personal inventory of an individual or individual's property is stored, said storage medium being locatable on a server system remote to the location of the individual's property such that in the event of a loss of the property, the personal inventory is accessible to provide comprehensive information related to the property; and
providing access to a link to said server system having or being linked to said storage medium wherein said link is either provided at the conclusion of the online transaction wherein the option of storing information related to an on-line purchase is provided or via an Internet communications link in a non-online retail purchase transaction wherein data in computer readable format is submitted to said server system in communication with said storage medium.

17. The medium of claim 16 wherein the method further comprises:
inquiring whether the consumer has a user id and password allowing for access to an account related to said storage medium;
obtaining information, if necessary to open a new account related to said storage medium;
providing access to an individual account wherein the data is related to personal property of the consumer and is stored into a database corresponding to an account related to said storage medium; and
providing the option of forwarding data to a server system of an insurance company.

18. The medium of claim 17, wherein the data includes any one of the following: invoice information, product specifications, warranty information, operation manuals, manufacturer and product serial number.

19. The medium as in claim 18, wherein a first entity provides and maintains said storage medium and a second entity provides and maintains said server system of said insurance company.

20. The medium as in claim 19, wherein said first entity and said second entity are one and the same.

21. A system for providing and updating a personal inventory of personal belongings during an on-line transaction, the system comprising:
at least one computer server linked to a network and providing access to a storage medium wherein the personal inventory of an individual or individual's property can be stored, said storage medium being at a location remote to the location of the individual's property such that in the event of a loss of the property, the personal inventory stored in said storage medium is accessible to provide comprehensive information related to the property; and
an interface to said storage medium, said interface executes an algorithm for storing information related to the on-line transaction into said storage medium, said algorithm executing the following commands during the on-line transaction:
inquiring whether the individual has a user id and password allowing the individual to access an account related to said storage medium;
obtaining information to open a new account related to said storage medium;
providing access to an individual account of said storage medium wherein information related to the on-line transaction is stored into a database corresponding to said individual account;
providing the option of forwarding information related to the on-line transaction to a server system of an insurance company; and
updating the information contained in the personal inventory by accessing said storage medium via a network communications link wherein data related to the on-line transaction in computer readable format is submitted to said storage medium.

22. The system as in claim 21, wherein the on-line transaction is a retail purchase performed by accessing a retail server via a network connection to said retail server, said network connection being provided by a computer.

23. The system as in claim 21, wherein said interface is provided by a computer configured to access said network.
